(19) United States
(12) Patent Application Publication
(10) Pub. No.: US 2006/0095238 A1
(43) Pub. Date: May 4, 2006

(54) Pattern extraction computational algorithm, design program and simulator

(75) Inventors: Morihiko Ikegaya, Tokyo (JP); Ken Takei, Tokyo (JP); Tomoyuki Ogawa, Tokyo (JP)

Correspondence Address: FOLEY AND LARDNER LLP;SUITE 500, 3000 K STREET NW, WASHINGTON, DC, 20007, US

(73) Assignee: HITACHI CABLE. LTD.

(21) Appl. No.: 11/253,808

(22) Filed: Oct. 20, 2005

(30) Foreign Application Priority Data
Oct. 20, 2004 (JP) 2004-305872

(51) Int. Cl. G06F 17/10

(52) U.S. Cl. 703/2

(57) ABSTRACT

A pattern extraction computational algorithm has: using a bus, a CPU, a storage area, an input and an output of a computer to conduct the pattern extraction computational algorithm; storing a size of a limited area, a size of a minute area, a starting point from which the minute area is arranged, a matrix with information on an attribute of an element, and an matrix with information on the minute area in the storage area; and patterning a structure based on a topology composed of a plurality of elements with attributes by using a rule in the size of the limited area to extract all patterns to accord to the topology.

The present application is based on Japanese patent application No. 2004-305872, the entire contents of which are incorporated herein by reference.

### BACKGROUND OF THE INVENTION

1. Field of the Invention

The invention relates to a pattern extraction computational algorithm that develops a certain pattern, in a limited size, for a structure based on a topology composed of plural components with attributes.

2. Description of the Related Art

An example of the structure based on a topology composed of plural components with attributes is a transmission line.

The transmission line is a component of an electrical circuit, which is formed on a printed circuit board (hereinafter referred collectively to as circuit board) with a single-layer or multilayer structure. Various electrical appliances operate with the circuit board installed therein. However, according as recent electrical appliances are downsized and low-profiled, it is required to reduce the area or volume of the circuit board installed therein. Thus, the arrangement on the circuit board of the transmission line is more complex such as placed in three dimensions. Because of this, there may be caused problems such as increase in manufacturing cost and prolonged design cycle.

One of factors to cause the above problems is that, when the arrangement of a transmission line is rendered in a limited size and space, the arrangement is personally determined by a designer. Namely, due to empirical knowledge of the designer, it takes a large amount of time and effort in the arrangement since a number of methods for the arrangement actually exist. As a result, it may be required to redesign the arrangement more than once.

Also, structures based on the other topology such as indoor electrical wiring, LAN cable wiring, cable wiring in a casing, arrangement of buildings or water channels are rendered in a limited region. However, theses wirings and arrangements are also often determined by empirical knowledge of the designer. Therefore, the same problems as described earlier will be caused therein.

Japanese patent No. 3251686 and JP-A-2004-199161 disclose representative methods for rendering automatically the arrangement of the structure based on a topology. These methods suggest that an optimum arrangement and design method is offered according to each use. However, in these methods, dependent on conditions used in optimization, information about the other candidates eliminated apriori cannot be obtained. Therefore, a comprehensive good answer obtainable in taking account of the other evaluation criterion such as a cost may be overlooked. Furthermore, since they need a number of storage areas in computation, there may be caused a problem that the cost of a computer to be used increases.

### SUMMARY OF THE INVENTION

It is an object of the invention to provide a pattern extraction computational algorithm that, for an issue that a structure based on a topology is to be arranged in a limited size and space, all arrangement patterns allocable actually can be extracted by a computer with a smaller storage area.

According to one aspect of the invention, a pattern extraction computational algorithm comprises:

using a bus, a CPU, a storage area, an input and an output of a computer to conduct the pattern extraction computational algorithm;

storing a size of a limited area, a size of a minute area, a starting point from which the minute area is arranged, a matrix with information on an attribute of an element, and an matrix with information on the minute area in the storage area; and

patterning a structure based on a topology composed of a plurality of elements with attributes by using a rule in the size of the limited area to extract all patterns to accord to the topology.

In the invention described above, the next modifications or changes may be made.

(i) The rule comprises to divide the size of the limited area into minute areas and to arrange sequentially the minute area into each of the minute areas.

(ii) The storage area comprises a matrix with information on a attribute of the plurality of elements, a storage area with information on the size of the limited area, a storage area with information on the size of the minute area, and a storage area with information on the starting point from which the minute area is arranged in the size of the limited area.

(iii) The storage area further includes a matrix with information on the minute area.

(iv) The matrix with information on the attribute is used to determine the number of times to sequentially arrange the minute segment.

(v) The matrix with information on the attribute and the matrix with information on the minute segment are used to determine the direction of minute segment to be sequentially arranged.

(vi) The matrix with information on the attribute and the matrix with information on the minute segment are used to determine the number of the minute segment to be sequentially arranged.

(vii) The matrix with information on the minute area is updated in every arrangement of the minute segment.

(viii) The number of times to sequentially arrange the minute segment is determined by standardizing the attribute of the element by dimensions of the minute segment.

(ix) The direction of minute segment to be sequentially arranged is determined by using a random function.

(x) The direction of minute segment to be sequentially arranged is determined by using the number of other minute segments adjacent to the minute segment.

(xi) The update of the matrix with information on the minute area in every arrangement of the minute segment is conduced by using an identifier comprising a numerical number, a character and a bit.

(xii) The update of the matrix with information on the minute area in every arrangement of the minute segment is conducted by the existence of the minute segment sequentially arranged.

(xiii) Information on the arrangement of the minute segment is written into the matrix with information on the minute area in the update for every arrangement of the minute segment.

(xiv) The inputting to the corresponding storage area of the size of the limited area, the size of the minute area, and the starting point from which the minute area is arranged is conducted by the reading of an electronic file or a dedicated user interface.

(xv) Writing into the matrix with information on the attribute of the element is conducted by the reading of an electronic file or a dedicated user interface.

(xvi) All the patterns to accord to the topology are stored in an electronic file.

(xvii) An arrangement pattern that comprises a numerical number, a character and a bit is output as a result of the algorithm.

(xviii) A coordinate value of an arrangement pattern is output as a result of the algorithm.

(xix) The attribute of the element is composed in two dimensional structure of a length and a width thereof.

(xx) The attribute of the element is composed in three dimensional structure of a length, a width and a height or thickness thereof.

(xxi) The attribute of the element comprises an electrical characteristic such as a potential and a magnetism.

(xxii) The attribute of the element comprises a fluid characteristic such a quantity of heat or water.

According to another aspect of the invention, a design program for automatically arranging a structure based on a topology comprises:

the pattern extraction computational algorithm as described above.

According to another aspect of the invention, a simulator for the design or characteristic analysis of an electrical circuit comprises:

the pattern extraction computational algorithm as described above.

According to another aspect of the invention, a simulator for an electromagnetic characteristic analysis comprises:

the pattern extraction computational algorithm as described above.

According to another aspect of the invention, a simulator for a fluid characteristic analysis comprises:

the pattern extraction computational algorithm as described above.

### BRIEF DESCRIPTION OF THE DRAWINGS

The preferred embodiments according to the invention will be explained below referring to the drawings, wherein:

FIG. 1 is a block diagram showing a user interface in a pattern extraction computational algorithm of the invention;

FIG. 2 is a block diagram showing a composition of a computer to conduct the pattern extraction computational algorithm of the invention, where the computer is composed of a CPU, a bus, storage areas, an input and an output;

FIG. 3 is a diagram showing an example of a topology used in the invention;

FIG. 4 is a diagram showing a limited region in which a structure based on a topology used in the invention is placed;

FIG. 5 shows an example of an electronic file to be read in conducting a pattern extraction computational algorithm of the invention;

FIG. 6 is a flow chart showing a pattern extraction computational algorithm of the invention;

FIG. 7 is a diagram showing a segmented limited region used in the invention;

FIG. 8 is a table showing sequences used in the invention;

FIG. 9 is a diagram showing an algorithm of the invention;

FIG. 10 is a diagram showing an algorithm of the invention;

FIG. 11 is a diagram showing an algorithm of the invention;

FIG. 12 is a diagram showing an algorithm of the invention;

FIG. 13 is a diagram showing an algorithm of the invention;

FIG. 14 is a diagram showing computed arrangement patterns according to the invention;

FIG. 15 is a diagram showing computed arrangement patterns in a first preferred embodiment of the invention;

FIG. 16 is a diagram showing a computed arrangement pattern in a second preferred embodiment of the invention;

FIG. 17 is a diagram showing a topology in a third preferred embodiment of the invention;

FIG. 18 is a diagram showing a computed arrangement pattern in the third preferred embodiment of the invention;

FIG. 19 is a diagram showing a computed arrangement pattern in the third preferred embodiment of the invention;

FIG. 20 is a diagram showing a segmented arrangement region in a fourth preferred embodiment of the invention;

FIG. 21 is a perspective view showing a circuit board in the fourth embodiment of the invention;

FIG. 22 is a diagram showing a segmented arrangement region in a fifth preferred embodiment of the invention;

FIG. 23 is a perspective view showing a circuit board in the fifth embodiment of the invention;

FIG. 24 is a diagram showing a segmented arrangement region in a sixth preferred embodiment of the invention;

FIG. 25 is a perspective view showing a circuit board in the sixth embodiment of the invention;

FIG. 26 is a perspective view showing a circuit board in a seventh preferred embodiment of the invention;

FIG. 27 is a diagram showing a segmented structure in the seventh embodiment of the invention;

FIG. 28 is a diagram showing a computed arrangement pattern in the seventh embodiment of the invention;

FIG. 29 is a diagram showing a topology of a transmission line in an eighth preferred embodiment of the invention;

FIG. 30 is a diagram showing a computed arrangement pattern in the eighth embodiment of the invention;

FIG. 31 is a diagram showing a computed arrangement pattern in a ninth preferred embodiment of the invention; and

FIG. 32 is a diagram showing a computed arrangement pattern in a tenth preferred embodiment of the invention.

### DETAILED DESCRIPTION OF THE PREFERRED EMBODIMENTS

A computational algorithm of the invention is conducted such that a limited size and space to arrange a structure based on a topology is divided into minute areas with an arbitrary shape, a starting point of the arrangement is determined within the minute area, the structure is patterned by sequentially arranging a neighboring minute area from the starting point while using the attribute of plural elements composing the topology, all arrangement patterns according to the topology which can be placed in the limited size and space are finally computed.

When a characteristic analysis is conducted by using the shape for the limited size and space to arrange the structure based on the topology and using further the computed arrangement pattern, the shape of the segment may be optionally triangle or square depending on segmentation of a computation region based on its method.

The computational algorithm of the invention to sequentially arrange the structure based on the topology by using the minute area is rendered to a computation processing that uses information such as an attribute of an element composing the topology, the number of branch points, and the number of elements to be branched from the branch point. Meanwhile, this information means an attribute of an element, dimensions of a limited size, and dimensions of a minute area used in the pattern extraction computational algorithm of the invention. These can be defined, when the computational algorithm of the invention is conducted, by using a numerical value or a character to be inputted by a user such as a designer through an electronic file read in conducting the pattern extraction computational algorithm of the invention or a graphical user interface.

The pattern extraction computational algorithm of the invention allows the arrangement of the structure based on the topology to be conducted optionally in a plane (in two dimensions) or stericaly (in three dimensions). Thus, the computation processing is conducted by using information such as a limited size and space and a composition for the arrangement.

The pattern extraction computational algorithm of the invention is conducted such that the number of sequential arrangements of minute area is determined by standardizing an attribute about a direction to sequentially arrange each element by dimensions of the minute area.

The pattern extraction computational algorithm of the invention is conducted such that a direction to sequentially arrange each element is determined by using information about the limited size and space to conduct the arrangement.

The pattern extraction computational algorithm of the invention is conducted such that, when reaching a branch point of topology in the process of sequentially arranging the minute area, the number of directions to sequentially arrange from the minute area as the branch point is determined by using information about the attribute of an element.

The pattern extraction computational algorithm of the invention may be conducted such that, by previously setting a region not to arrange the structure within the limited size and space to conduct the arrangement of the structure based on the topology or by controlling information about the limited size and space in each arrangement of minute area, the arrangement of minute area is not conducted in the region.

Further, the pattern extraction computational algorithm of the invention may be conducted such that, after completing the computation of the arrangement of the structure based on the topology, the characteristic of an unused region or preset not-to-arrange region is changed according to the object.

A preferred embodiment of the invention will be explained below referring to the attached drawings.

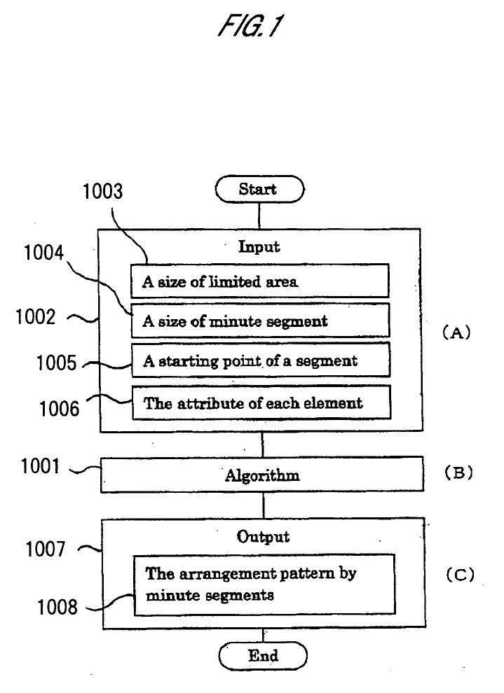

FIG. 1 is a block diagram showing a user interface in a pattern extraction computational algorithm of the invention.

The pattern extraction computational algorithm 1001 of the invention comprises, as items of input 1002, a size 1003 of limited area to sequentially arrange a minute area, a size 1004 of the minute area, a starting point 1005 to arrange the minute area, and an attribute 1006 of an element. Output 1007 comprises an arrangement pattern 1008 of the minute area.

FIG. 2 is a block diagram showing a composition of a computer to conduct the pattern extraction computational algorithm of the invention, where the computer is composed of a bus 1010, a CPU 1011, a storage area 1012, an input 1013 and an output 1014.

As shown in FIG. 2, the pattern extraction computational algorithm of the invention conducts a computation by using a size 1015 of a limited area, a size 1016 of a minute area, a starting point 1017 to arrange the minute area, a matrix 1018 with information on the attribute of each element, and a matrix 1019 with information on the minute area.

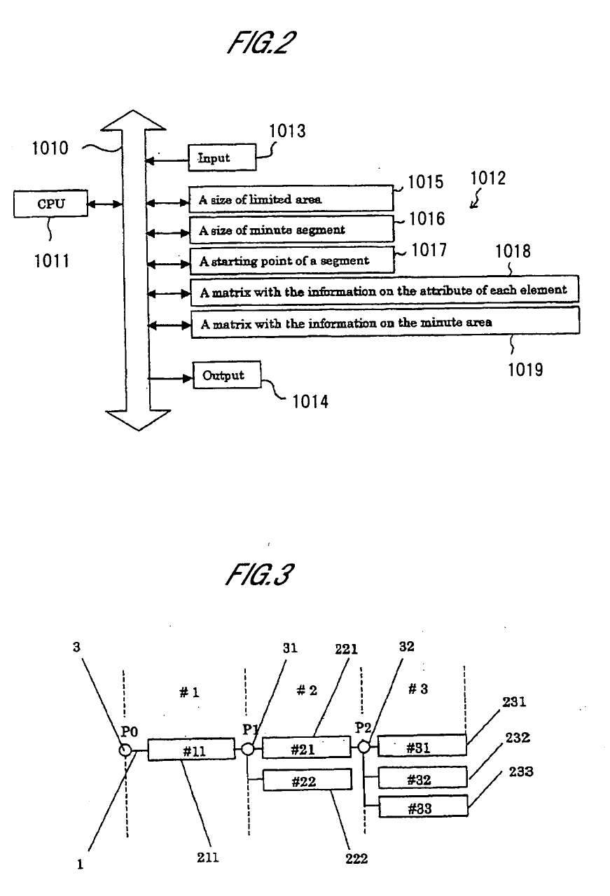

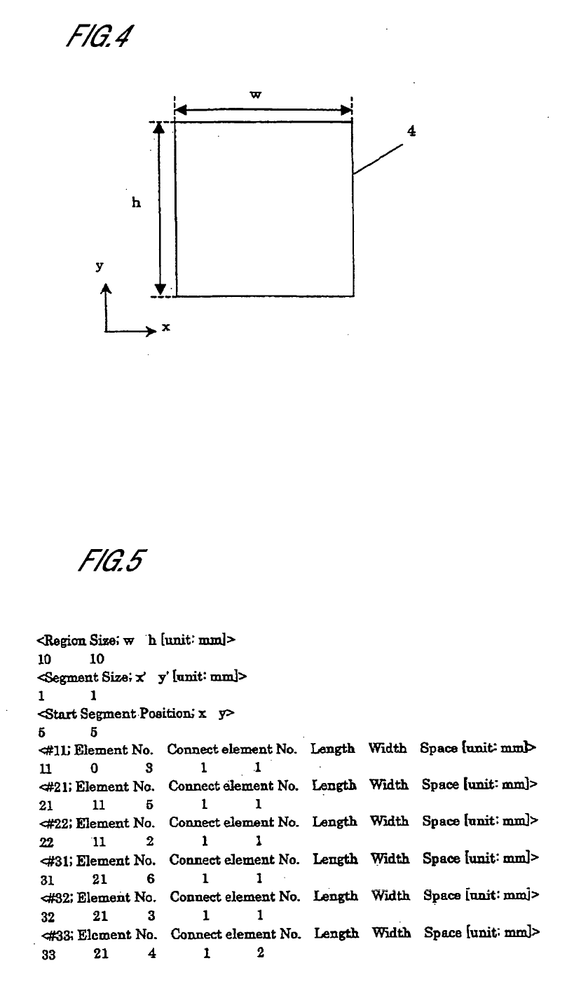

Next, the features of the pattern extraction computational algorithm in an embodiment of the invention will be explained by using a process that a structure based on a topology 1 composed of elements 211 to 233, a starting point 3 and branch points 31, 32 as shown in FIG. 3 is sequentially arranged in a limited arrangement area 4 defined by a width w and a height h as shown in FIG. 4. Meanwhile, #11 to #33 as shown in FIG. 3 represent serial numbers of the elements 211 to 233. The higher digit of these serial numbers indicates that what number stage of the topology 1 the element concerned belongs to, each stage being defined by the starting point 3 and the branch points 31 and 32. The lower digit thereof indicates that what number element on the stage to which the element belongs the element concerned is. Further, P1 and P2 are serial numbers of the branch points 31, 32. P0 is the starting point of the topology 1.

At first, a read file is produced which describes information such as a length and a width as attributes of the elements 211 to 233 to be used by the pattern extraction computational algorithm of the invention. Meanwhile, the attributes maybe electric, magnetic, thermal, pressure, stress etc. For example, the electric attributes include electric field strength, the magnetic attributes include magnetic repulsive force, the thermal attributes include thermal conduction quantity, the pressure attributes include expansion quantity, and the stress attributes include allowance in bending.

FIG. 5 shows an example of an electronic file to be read in conducting a pattern extraction computational algorithm of the invention, where the electronic file describes an attribute of an element, dimensions of a limited size and dimensions of a minute area.

The electronic file as shown in FIG. 5 is used in conducting two-dimensional arrangement by using a square minute area. First, by the first to second lines, a size of limited area to arrange the structure based on the topology is specified. In this example, the width w and the height h in FIG. 4 are each 10 mm. Then, by the third to fourth lines, a size of minute area into which the limited area specified by the first to second lines is divided is specified. In this example, the minute area is a 1 mm×1 mm square. Then, by the fifth to sixth lines, a position of the minute area to be the starting point in arranging the structure based on the topology is specified. Then, the seventh to eighteenth lines each describe information of the elements #11 to #33 as shown in FIG. 3. The information contents are in sequence “serial number”, “serial number of the other element to be connected”, “length and width”, and “distance from the other element to be held” of each element. For example, the element #11 information is defined in the seventh to eighth lines such that its serial number is 11, it is connected to the starting point of the structure, having a length of 3 mm and a width of 1 mm, holding a space of 1 mm from the other element, by a description “11 0 3 1 1”. Similarly, the element #21 information is defined in the ninth to tenth lines such that its serial number is 21, it is connected to the end of the element 11, having a length of 5 mm and a width of 1 mm, holding a space of 1 mm from the other element, by a description “21 11 5 1 1”. The other element information in the eleventh and under lines is defined in like manner.

Meanwhile, instead of producing the above electronic file, a graphical user interface may be used.

By using the attribute of an element, dimensions of a limited size and dimensions of a minute area as shown in FIG. 5, the pattern extraction computational algorithm of the invention is conducted. A computation process thereof will be explained below.

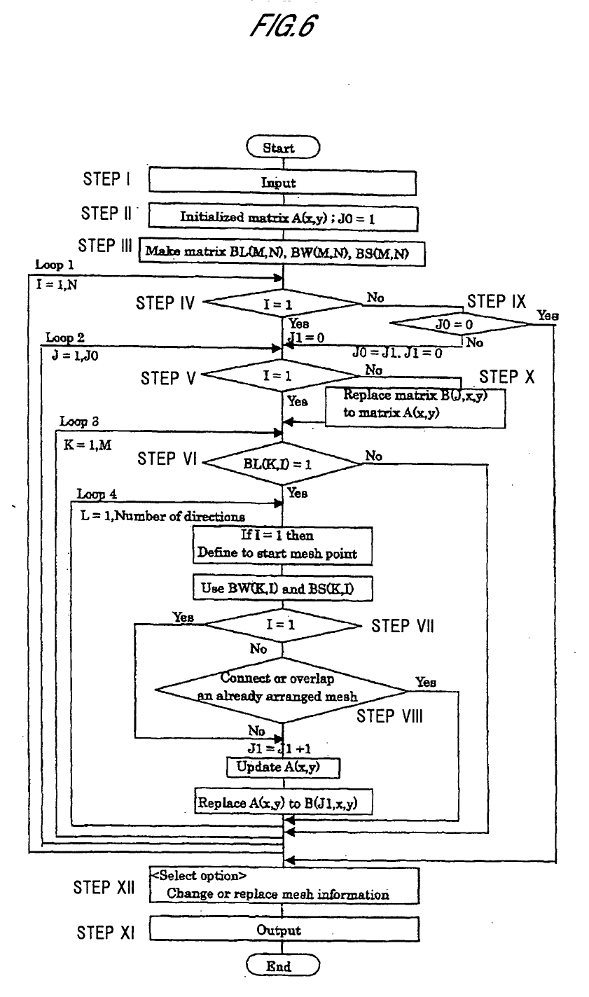

FIG. 6 is a flow chart showing a pattern extraction computational algorithm in another preferred embodiment of the invention. The part (B) in FIG. 1 is detailed in FIG. 6 except the input (A) and the output (C).

The computation process is conducted such that, after reading the abovementioned information, a matrix with information of the minute area used in arrangement is initialized and a matrix with the attributes information is produced. Then, quadruple computation loops for conducting the sequential arrangement are executed to search all patterns to accord to the topology, and the computation results are output. The algorithm process will be detailed below.

In executing the pattern extraction computational algorithm as shown in FIG. 6, in Step I, a file which describes computation parameters like the example as shown in FIG. 5 is read. Then, based on information read from the file, preparation and definition for executing the computation in Steps II and III are conducted.

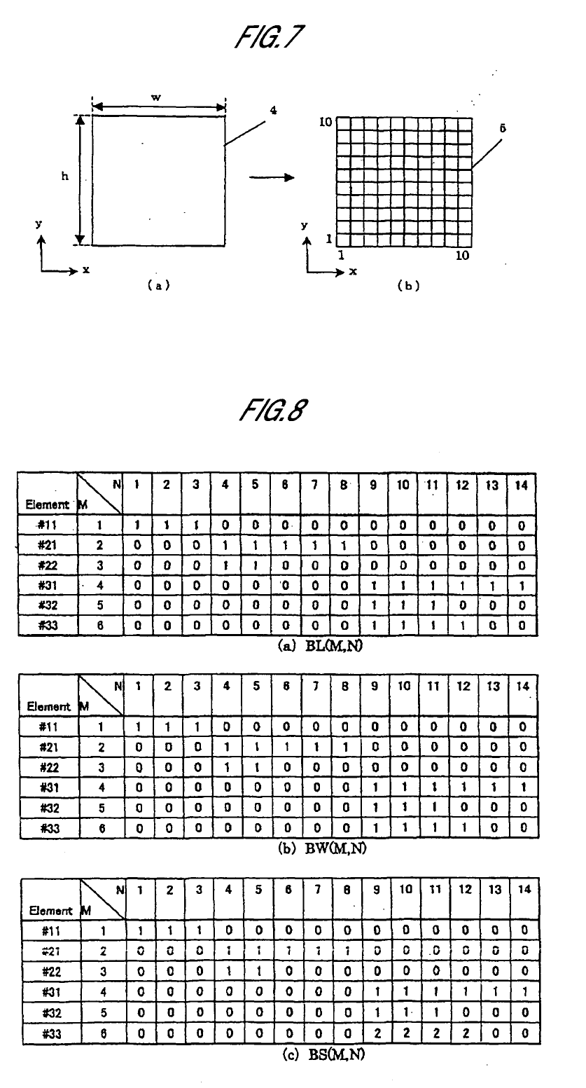

In Step II, a size of the limited area to arrange the structure based on the topology is specified from information in the first to second lines as shown in FIG. 5. Then, based on the size of the divided minute area described in the third to fourth lines as shown in FIG. 5, a limited arrangement region 4 as shown in FIG. 7(a) is segmented and a matrix 5 with information of minute area as shown in FIG. 7(b) is defined. Further, the matrix 5 with the minute area information is defined as A(x,y). Parameter J0 is set to be J0=1.

Then, in Step III, a matrix with the attribute information of each element sequentially positioned-is established.

FIG. 8 shows matrixes with the attribute information of each element sequentially positioned.

The matrixes (a) to (c) are established based on descriptions about the attribute of elements in the computation parameter file as shown in FIG. 5, where (a) represents a length: BL(M,N), (b) represents a width: BW(M,N), and (c) represents a space to be held: BS(M,N). The matrixes (a) to (c) are defined by a matrix with a step number N since the pattern extraction computational algorithm of the invention is to sequentially arrange the structure by using the minute area to be segmented of the limited region. Meanwhile, M is the number of elements. The numerical values described in (a) to (c) are computed by the matrix with the attribute of each element and the dimensions of minute area, and are the number of minute areas used in expressing the pattern.

The method of determining the numerical values described in the matrixes in FIG. 8 will be explained below.

As shown in FIG. 3, the element #11 is the first element (M=1) to be positioned at the starting point of the structure. As shown in FIG. 5, the minute area used in the segmentation of the limited region is a square of 1 mm×1 mm, and the length of the element #11 is 3 mm. Dividing this length by the length of a side of the minute area gives 3. Thus, the length of the element #11 is expressed by three continuous minute areas. Provided that the pattern extraction computational algorithm of the invention needs one step to arrange one segment, it can be determined that the element #11 is present in three steps. Accordingly, as shown in FIG. 8(a), “1” is inputted to BL(1,1-3). Then, as shown in FIG. 3, the other element is not present at the same stage #1 of the topology as the element #11, and therefore “0” is inputted to BL(2-6, 1-3). Simultaneously, to BW(M,N) in FIG. 8(b) and BS(M,N) in FIG. 8(c) are inputted values to get dividing the width and space by the size of the minute area based on the existence of the element.

Then, as shown in FIG. 3, the element connected with the end of the element #11 is two elements, #21 (M=2) and #22 (M=3). The element #21 and #22 can be present from N=4 in FIG. 8 (a) since the element #11 is present at step N=1-3. Like the element #11, the length of #21 and #22 is got being divided by the size of the minute area, and “1” is inputted from N=4 to step N with the element present in FIG. 8(a). Further, “0” is inputted to step with no element and to the other element (M=4-6) not present at the same stage #2 of the topology as the elements #21 and #22. Further, as described earlier, simultaneously, the corresponding values are inputted to FIGS. 8(b) and (c). After that, in like manner, the matrix with the attribute information is established on the elements #31 (M=4), #32 (M=5) and #33 (M=6). As a result, the matrix as shown in FIG. 8(a)-(c) is completed.

Since the matrix with the attribute information of each element is established as described above, the maximum value of step N in BL(M,N), BW(M,N) and BS(M,N) used for the pattern extraction computational algorithm of the invention is got by dividing the sum of the longest elements in each stage of the topology by the size of the minute area. In this embodiment, the sum of 3 mm in the element #11, 5 mm in the element #21, and 6 mm in the element #31 is divided by 1 mm×1 mm, the size of the square minute area. As a result, the maximum value of step N in FIG. 8 is 14.

After the matrix with the attribute information of each element is thus established, the pattern extraction computational algorithm of the invention proceeds to the quadruple loop algorithm.

At first, Loop 1 is repeated the number of the maximum value of step number to compute all conditions of each step. Then, Loop 2 is repeated the number of arrangement pattern candidates computed by Loop 3 and Loop 4 when Loop 1 is I=1. Then, Loop 3 is repeated the number of each element present in step number I. Then, Loop 4 is repeated the number of neighboring minute area where, for a minute area arranged, the other neighboring minute area is ready adjacent to each side of the arranged minute area. Meanwhile, in this embodiment, the number of this repetition is 4 (L=1-4) since the square minute area is used. The processing of the quadruple loop will be explained in sequence below.

In the first processing of the quadruple loop, Loop 1 uses I=1 and Loop 2 uses J=1. When I=1, no processing is conducted in Step IV of Loop 1 and in Step V of Loop 2. Then, in Loop 3, Step VI is satisfied by the matrix BL (1,1) with the attribute information of element when K=1, proceeding to Loop 4. However, due to the matrix BL (2-6,1)=0 with the attribute information of element, Loop 4 is executed only when K=1 in Loop 3. In Loop 4, when I=1, identifier 11 is, as initialization of the computation, inputted which is as shown in FIG. 9(b) arranged at coordinate (5,5) of a segment as the starting point of the structure based on the topology. Meanwhile, though the pattern extraction computational algorithm of the invention actually uses a numerical value or a character to express the identifier in the matrix with information of minute area, this embodiment hereinafter expresses the identifier by applying a black mark (▪) to the segment or by using various codes, for convenience.

Then, by using the matrixes BW (1,1) and BS (1,1) with the attribute information of element, the identifier 11 for the width and element space is inputted. In this case, because of the matrix BW(1,1)=1 with the attribute information of element in FIG. 3, it is still as shown in FIG. 9(b). Then, omitting Step VIII, parameter J1 is added by 1. J1 is to record the number of arrangement pattern candidates. Then, the identifier is inputted to the matrix with information of minute area to update, and matrix A(x,y) with information of minute area to be a candidate of the arrangement pattern is replaced into a storage matrix B(J1,x,y). This processing is repeated four times, then returning to Loop 1. Thereby, J1=4 is taken, and the arrangement information as shown in FIG. 9(b) is stored in the storage matrix B(1-4,x,y).

Returning to Loop 1, I=2 is taken. Based on I=2, Step IV transfers the processing to Step IX. Step IX conducts the definition of the repeat number of Loop 2 and the initialization of J1. In Step IX, Loop 1 transfers 4 as the repeat number of Loop 2, J1=0, and I=2 to Loop 2. In Loop 2, based on I=2, Step V transfers the processing to Step X. Step X, when I=1, replaces the storage matrix B(J,x,y) stored in Loop 4 into the matrix A(x,y) with information of minute area according to the change of J, and transfers it to Loop 3. In Loop 3, when K=1, the matrix BL(1,2)=1 with the attribute information of element is got, then proceeding to Loop 4. In Loop 4, the processing of Step VIII is repeated four times by using the matrix BW(1,1) and BS(1,1) with the attribute information of element. 18.

FIG. 10 is a diagram showing the results computed by this processing of Step VIII.

The matrix A(x,y) with information of the minute area as shown at the center in FIG. 10 is a result computed when I=1. In the matrix at the center in FIG. 10, identifiers ◯ 12 are inputted to four segments adjacent to the identifier ▪ 11 already arranged at the coordinate (5,5). The identifier ◯ 12 represents a segment to be connected to the segment with the identifier ▪ 11 inputted therein. This means that the arrangement of the structure can be extended in four directions. Since the repeat number of Loop 4 is four times, each direction can be selected at each time. Around the matrix at the center in FIG. 10, four results with each identifier ▪ 11 newly added are shown that the matrix with information of the four minute areas is computed by the processing of Step VIII. Then, these results are stored into the storage matrix B(1-4,x,y), then returning to Loop 3 with J1=4 and repeating the computation in like manner, then returning to Loop 1 again and repeating the computation.

Meanwhile, the results as shown in FIG. 10 are obtained based on the setting of the attributes of element, the dimensions of the limited size and the dimensions of the minute area in this embodiment as shown in FIG. 5. Thus, they may be different depending on the setting of these information and the arrangement condition of the structure computed by the computation of each step.

Alternatively, a random function may be used for the selection of a direction to extend the structure arrangement with the segment connected continuously.

Next, an example of transition state of the structure arrangement computed based on the computation algorithm as shown in FIG. 6 will be further explained.

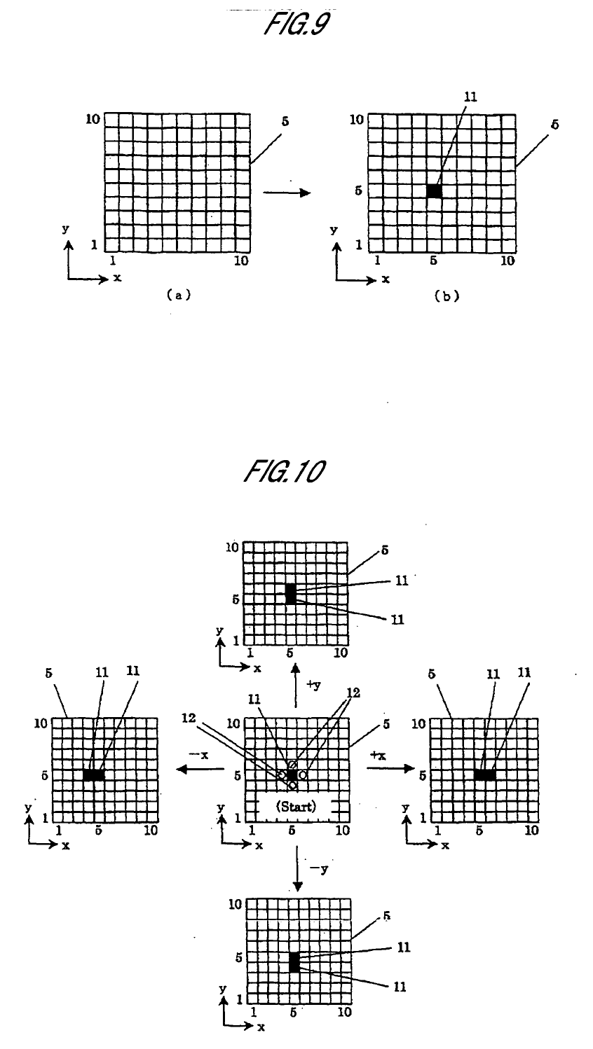

FIG. 11 shows that example. Step 1 in FIG. 11 is the result of when I=1 in the above explanation, and Step 2 is the result of when I=2, where the structure arrangement is extended to the +y direction. As shown, identifier X 13 in addition to the identifier ▪ 11 and the identifier ◯ 12 is inputted to the matrix A(x,y) with information of the minute area. The reason why the identifier ◯ 12 is present only at three segments is that the arrangement cannot be extended to the direction to overlap with the identifier ▪ 11 one step before. The identifier X 13 means a segment that the structure cannot be arranged. It can be inputted as well as the identifier ◯ 12 when updating the matrix A(x,y) with information of the minute area in Step VIII or later of Loop 4 in the computation algorithm as shown in FIG. 6, by using the matrixes BW(K,1) and BS(K,1) with the attribute information of element.

In detail, the sequence of the two identifiers ▪ 11 in Step 2 represents up to the second step of the element #11 (211), where the element #11 (211) has a width of BW(1,1-3)=1 mm and a space of BS(1,1-3)=1 mm from the other element. In Step 2, since the arrangement is extended to the +y direction, the identifiers X 13 are inputted around there in the ±x and −y directions of the identifier ▪ 11 (with the coordinate (5,5)) one step before by using the BS(1,1-3) so as to prioritize the holding of a space from the other element.

In the pattern extraction computational algorithm of the invention, the structure arrangement based on the topology proceeds by using these identifiers. Step 3 is the result of when I=3 in FIG. 6, where the arrangement is further extended to the +y direction. Like Step 2 abovementioned, the identifiers X 13 are inputted around the identifier ▪ 11 one step before. Meanwhile, in Step 3, the arrangement of the element #11 (211) ends based on the attribute of the element.

In Step 4, the arrangement is conducted for the elements #21 (221) and #22 (222). Step 4 is the result that, from the identifier ▪ 11 with a coordinate (5,7) in Step 3, the #21 (221) is extended to the +x direction and the #22 (222) is extended to the +y direction. An identifier ● 14 indicates that the #21 and #22 will contact each other when either of the #21 and #22 is extended in arrangement on the next step, and that the arrangement thereof is not allowed like the identifier X 13. As a result, on the next step, it is determined that the # 21 (221) can be extended to −x and +y directions, and the # 22 (222) can be extended only to +x direction.

Step 5 is the result that, like one step before, the #21 (221) is extended to the +x direction and the #22 (222) is extended to the +y direction. In Step 5, the arrangement of the element #22 (222) ends, and the identifiers X 13 are inputted to segments around the #22 (222) based on the matrix BS with the attribute information of element since the other element is not connected to the end of the #22 (222).

Step 6 is the result that the #21 (221) is further extended to the +x direction. The identifiers ● 12 and the identifiers X 13 are also inputted based on the arrangement.

As described above, the structure arrangement proceeds while updating the matrix A(x,y) with information of the minute area, as well as using the identifiers.

In the actual arrangement, one candidate in the arrangement direction of the structure may exceed the region for the matrix A(x,y) with information of the minute area. In this case, it is determined that the other direction is selected without selecting the candidate exceeding the region. FIG. 12 shows that example. As shown in FIG. 12, even when the identifier ▪ 11 reaches the boundary of the matrix A(x,y) in Step α, two ways of arrangements in the topology can be selected in the next Step α+1.

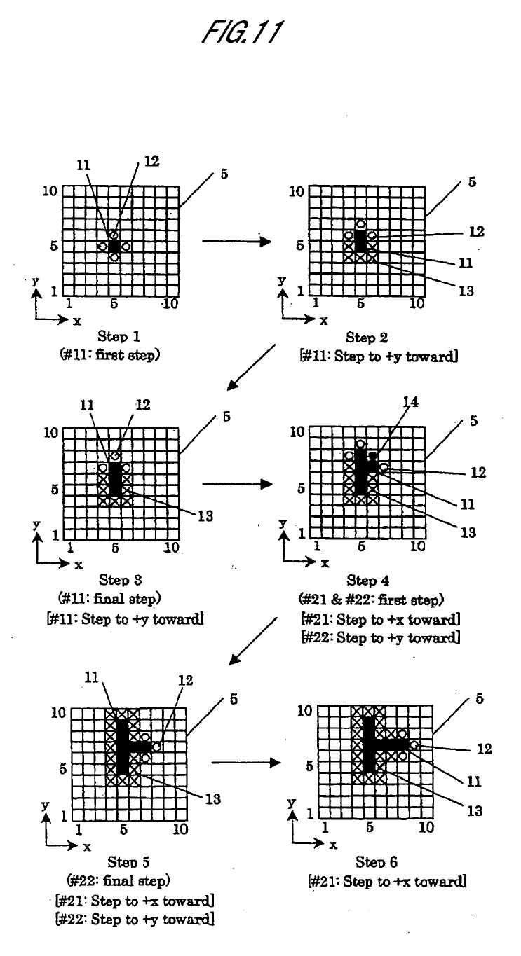

On the other hand, the advance direction of the arrangement may be blocked by the identifier X 13. FIG. 13 shows that example. As shown in FIG. 13, even when the identifier ▪ 11 contacts the identifier X 13 in Step α, two ways of arrangements in the topology can be selected in the next Step α+1.

As described above, the structure based on the topology is sequentially arranged by using the identifiers inputted to the matrix A(x,y) with information of the minute area and the matrix with the attribute information of element. Finally, when all steps are completed, all the arrangement patters to accord to the topology are outputted. Thus, the computation algorithm of the invention as shown in FIG. 6 ends.

FIG. 14 shows arrangement patterns obtained by the pattern extraction computational algorithm of the invention by using the attributes of elements, the dimensions of the limited size, and the dimensions of the minute area as shown in FIG. 5. As shown in FIG. 14, it will be understood that all the patterns are made in different arrangements. Thus, in the same topology, the plural arrangement patterns can be computed. Therefore, various arrangement ways can be considered in experimentally producing the computed arrangement patterns.

Accordingly, the pattern extraction computational algorithm of the invention can compute all arrangement patters allocable in arranging a structure based on a topology in a limited size and space.

Moreover, the pattern extraction computational algorithm of the invention can be conducted using a storage area about one fourth of the conventional algorithm. Thus, it can extract completely all patterns allocable while reducing the cost of computer. Therefore, the design cost can be reduced and the design period can be shortened.

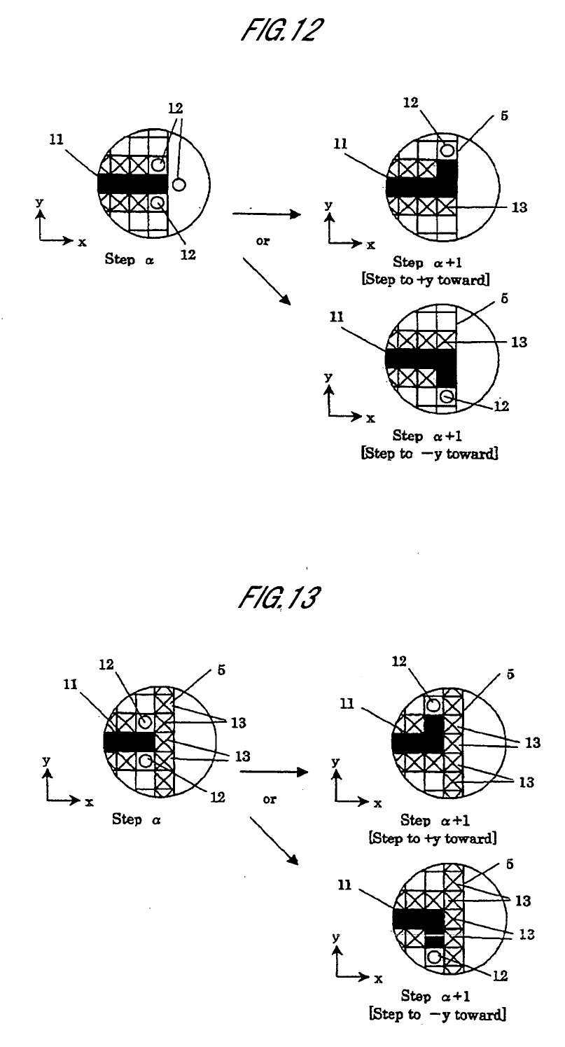

FIG. 15 shows arrangement patterns obtained by the pattern extraction computational algorithm of the invention, where, of the element attributes in FIG. 5, the width of elements #22 (222) and #32 (233) is set to be 2 mm and the starting point of the structure based on the topology is set to be coordinates (3,3) and (1,5). FIG. 15(a) shows an example in the case that the starting point of the structure is set to be the coordinate (3,3), and FIG. 15(b) shows an example in the case that the starting point of the structure is set to be the coordinate (1,5). As shown, it is found that the width of the element is expressed. Further, by changing the starting point of the structure, distinctive arrangement patterns are computed which are different from each other.

FIG. 16 shows an arrangement pattern obtained by the pattern extraction computational algorithm of the invention, where, of the element attributes in FIG. 5, the length of elements #22 (222) and #32 (233) is set to be 11 mm and the starting point of the structure based on the topology is set to be a coordinate (1,1). This pattern is distinct from those explained thus far in that most of the elements are arranged along the edge of the matrix 5 with information of the minute area. Since the pattern extraction computational algorithm of the invention thus computes all the arrangement patterns to accord to the topology, such a distinctive arrangement pattern can be obtained.

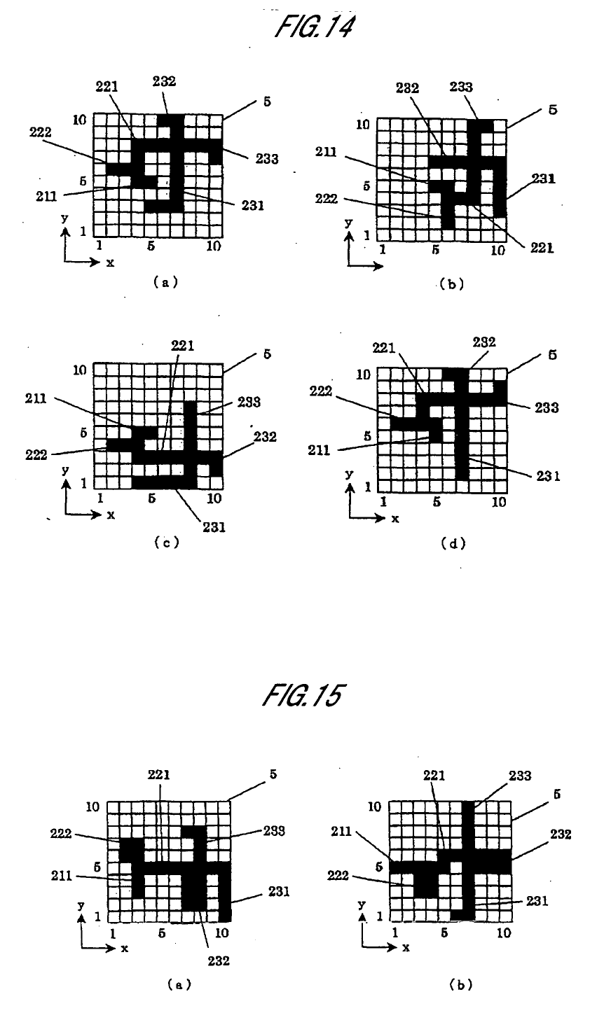

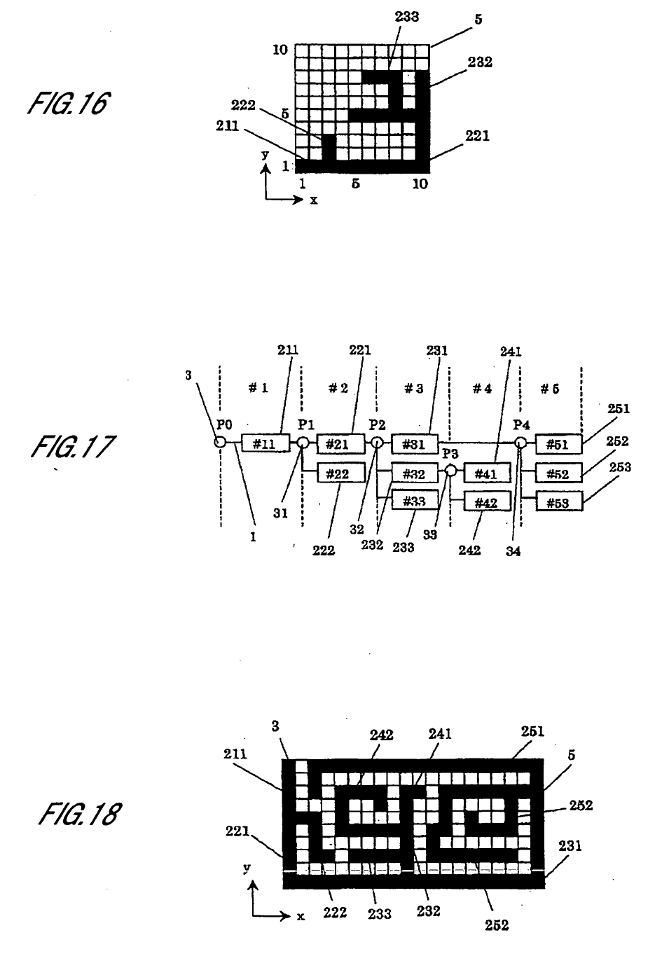

FIG. 17 shows a topology composed of eleven elements (211-253). With respect to this topology, FIGS. 18 and 19 show arrangement patterns obtained by the pattern extraction computational algorithm of the invention, where the starting point 3 for arranging the structure based on the topology is set to be at the corner of the matrix 5 with information of the minute area, and an information-inputting read file as shown in FIG. 5 is used in which attributes of the elements, dimensions of the limited size and dimensions of the minute area are described. Meanwhile, the attributes of the elements and the dimensions of the limited size used in FIGS. 18 and 19 are different from each other. As shown, the arrangement patters are rendered distinctive such that elements are arranged surrounding the edges of the matrix 5 with information of the minute area, and the other elements are arranged inside thereof. Furthermore, the elements arranged inside are closely extended so that it cannot be easily designed by means of human arrangement work.

FIG. 20 shows an arrangement pattern obtained by the pattern extraction computational algorithm of the invention, where its arrangement region is set such that a region 131 not to arrange any minute area is predetermined by the identifiers X 13 at a part of the matrix 5 with information of the minute area for arranging the structure based on the topology. As shown, it is found that, by the identifiers X 13, the structure can be arranged avoiding the predetermined region 131.

The above method that a region to not arrange the structure is predetermined in the arrangement region in computing the arrangement pattern for the structure based on the topology is useful in the case that, as shown in FIG. 21, the arrangement of an transmission line based on the topology is considered on a circuit board 6 on which a particular circuit 7 such as a device or module is mounted. Even for such a case, the pattern extraction computational algorithm of the invention can be flexibly applied.

The method that a region to not arrange the structure is predetermined in the arrangement region is useful in considering the arrangement while taking account of the property of the attribute. For example, when the attribute is electrical, the arrangement can be considered taking account of the influence of electric field strength and the prevention of interference between elements. When the attribute is magnetic, the arrangement can be considered taking account of the prevention of electrostatic damage and the reduction of magnetic repulsion between elements. When the attribute is thermal, the arrangement can be considered taking account of the prevention of element failure caused by heat conduction or radiant heat. When the attribute is pressure, the arrangement can be considered taking account of the influence of a defective element to the other element and the expansion of element. When the attribute is stress, the arrangement can be considered taking account of expected bending or vibration of element.

FIG. 22 shows an arrangement pattern obtained by the pattern extraction computational algorithm of the invention, where its arrangement region is set such that a region 132 not to arrange any minute area is predetermined by the identifiers X 13 all at edges of the matrix 5 with information of the minute area for arranging the structure based on the topology. As shown, it is found that, by the identifiers X 13, the structure can be arranged avoiding the predetermined region 132.

The above method that a region 8 to not arrange the structure is predetermined all at the edges of the arrangement region in computing the arrangement pattern for the structure based on the topology is useful in the case that, as shown in FIG. 23, the arrangement of an transmission line based on the topology is considered when a mount space is placed all at the edges of the circuit board 6, or when the actual arrangement region is not all the area of the circuit board 6 if taking account of the influence of a peripheral metallic element. Even for such a case, the pattern extraction computational algorithm of the invention can be flexibly applied.

FIG. 24 shows an arrangement pattern obtained by the pattern extraction computational algorithm of the invention, where its arrangement region is set such that a region 133 not to arrange any minute area is predetermined by the identifiers X 13 all at edges, except a part thereof, of the matrix 5 with information of the minute area for arranging the structure based on the topology. As shown, it is found that, by the identifiers X 13, the structure can be arranged avoiding the predetermined region 133.

The above method that a region 81 not to arrange the structure is predetermined all at the edges, except a part thereof, of the arrangement region in computing the arrangement pattern for the structure based on the topology is useful in the case that, as shown in FIG. 25, the arrangement of an transmission line based on the topology is considered when a mount space is placed at the edge of the circuit board 6, or when taking account of the influence of a peripheral metallic element, or when a part of the transmission line on the circuit board 6 is connected to an external device. Even for such a case, the pattern extraction computational algorithm of the invention can be flexibly applied.

FIG. 26(a) shows a three-layer circuit board 41 that arrangement of a transmission line is made in three dimensions. FIG. 26(b) shows a matrix 51 with information of the minute area that the circuit board 41 is divided into the minute areas.

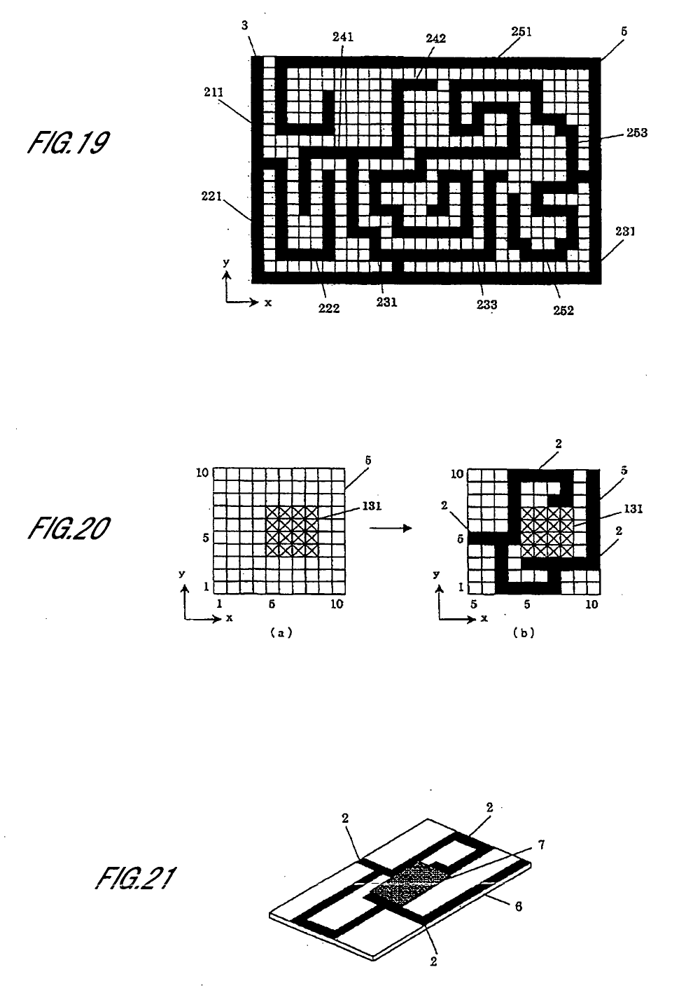

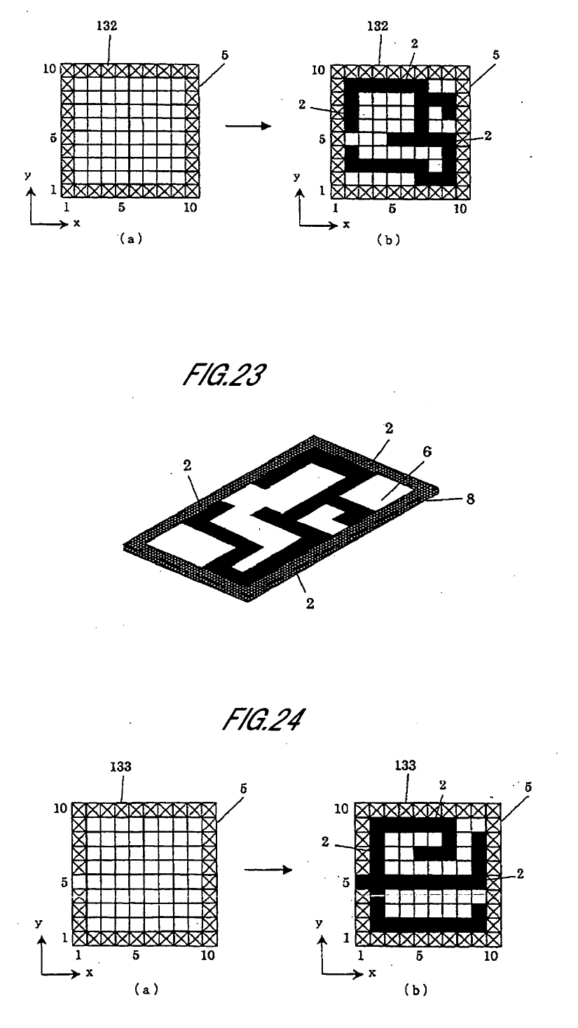

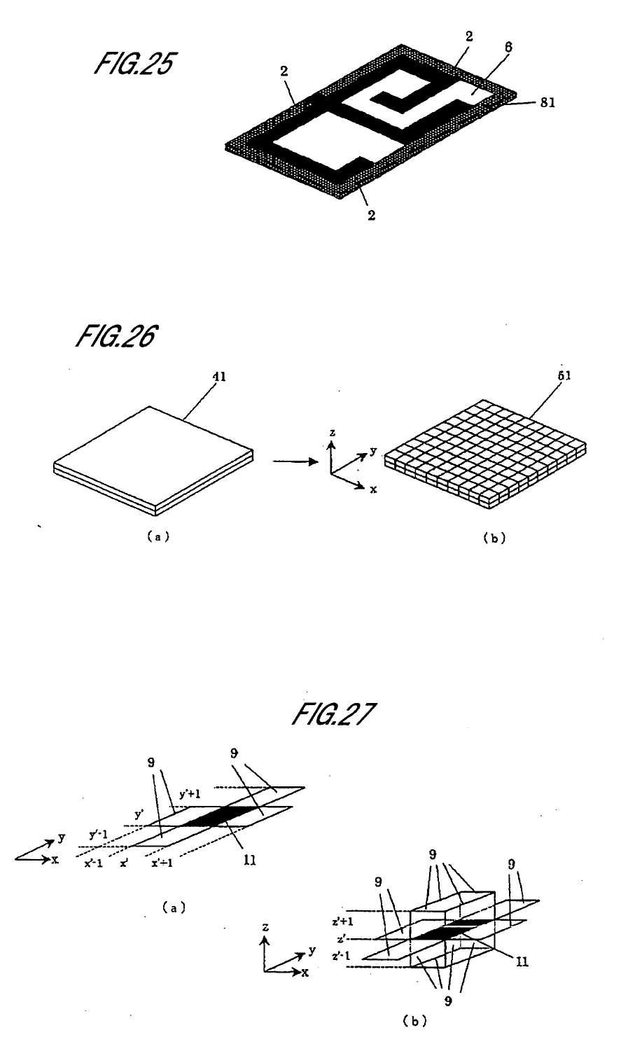

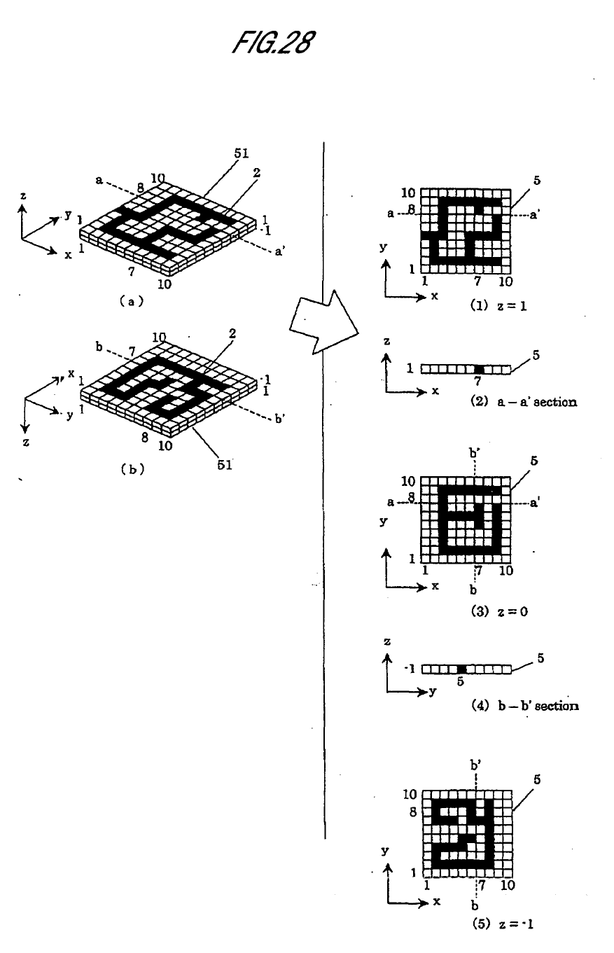

In conducting the steric arrangement, the direction to arrange the minute area is different from the planar arrangement (two-dimensional arrangement). FIG. 27 shows that difference. FIG. 27(a) shows the case that the structure arrangement is conducted in two dimensions, and FIG. 27(b) shows the case that the structure arrangement is conducted in three dimensions. In the case of the two-dimensional arrangement, minute areas 9 in four directions of ±x and ±y can be selected from a minute area 11 one step before. In contrast, in the case of the three-dimensional arrangement, minute areas 9 in twelve directions where eight directions adjacent to the four sides of the minute area 11 one step before are added can be selected. Even for this case, the pattern extraction computational algorithm of the invention can be easily applied such that the maximum number of Loop 4 as shown in the flow chart in FIG. 6 is changed to 12, and that the element attributes, the dimensions of the limited size, the dimensions of the minute area, and information of the arrangement region are changed according to the three dimensions.

FIG. 28 shows arrangement patterns of a structure based on a topology to be actually computed by the pattern extraction computational algorithm of the invention that is expanded from two dimensions to three dimensions. FIG. 28(a) shows a top face of the circuit board, and FIG. 28(b) shows a bottom face thereof. The circuit board as an arrangement region has a three-layer structure. In reality, there is a middle arrangement region (middle face) sandwiched by the top face in FIG. 28(a) and the bottom face in FIG. 28(b). Including this arrangement region, the broken views of all the arrangement patterns are shown in FIG. 28(1) to (5). FIG. 28(1) shows an arrangement pattern on the top face and FIG. 28(5) shows an arrangement pattern on the bottom face. FIG. 28(3) shows an arrangement pattern on the middle face at the middle arrangement region sandwiched by the top face and the bottom face. A pattern to connect between the top face and the middle face and a pattern to connect between the middle face and the bottom face are shown in FIG. 28(2) and FIG. 28(4), respectively.

The above method that the arrangement pattern of a structure based on a topology is computed in three-dimensional structure is useful in the case that the steric arrangement of a transmission line is considered for a multilayer circuit board while using a through-hole or pin.

Even for such a case, the pattern extraction computational algorithm of the invention can be flexibly applied.

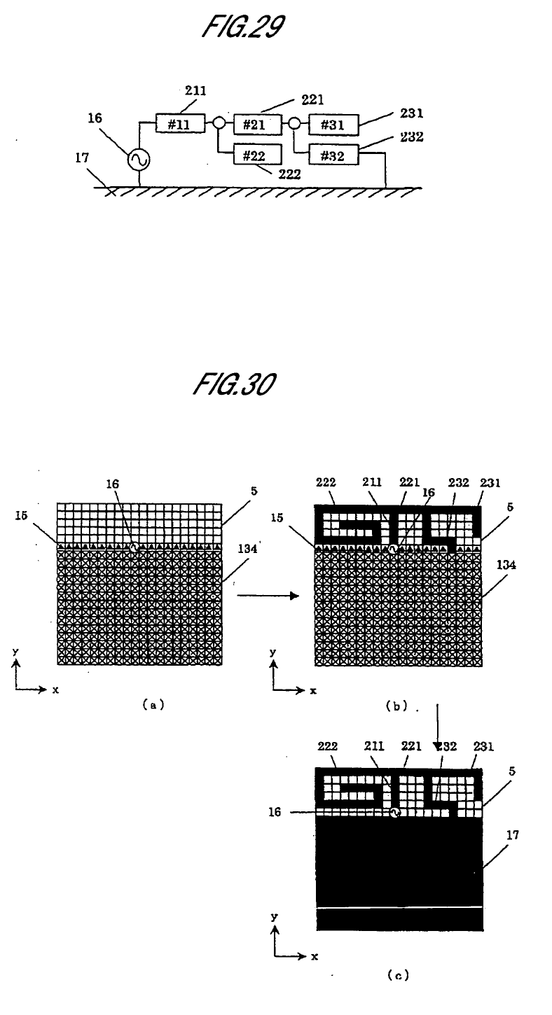

FIG. 29 shows a topology of a transmission line to serve as an antenna. This antenna is composed of the transmission line as a radiation element and an earthing conductive portion (ground), and the topology thereof is determined taking account of loss of the conductive transmission line so as to serve as an antenna. Further, it has an advantage that it can be formed planar.

FIG. 30 shows an arrangement pattern that the antenna structure based on the topology is computed by the pattern extraction computational algorithm of the invention.

First, as shown in FIG. 30(a), in order to secure the earthing conductive portion (ground), there is provided a region 134 not to arrange the segment with the identifiers X13 at the most part of the matrix with information of the minute area, and identifiers ▴ 15 and a feeding point 16 are in contact with the identifier X 13. The feeding point 16 is set to be the starting point of the structure arrangement. The identifier ▴ 15 indicates a minute area that an element #32 (232) can be selected only at the final step of the arrangement. Under these conditions, an arrangement pattern as shown in FIG. 30(b) is computed by the pattern extraction computational algorithm of the invention. It will be appreciated that the arrangement of the element #32 (232) ends at a position where the identifier ▴ 15 was located. After computing the arrangement pattern, all the identifiers X 13 in the region 1434 not to arrange the segment as shown in FIG. 30(a) are changed into the identifiers ▪ 11. Thereby, the structure arrangement as shown in FIG. 30(b) can be finally patterned as shown in FIG. 30(c) to form the earthing conductive portion (ground) 17. Meanwhile, the change of the identifier can be conducted in Step XII of the flow chart as shown in FIG. 6.

Even for the structure in this embodiment, the pattern extraction computational algorithm of the invention can be flexibly applied.

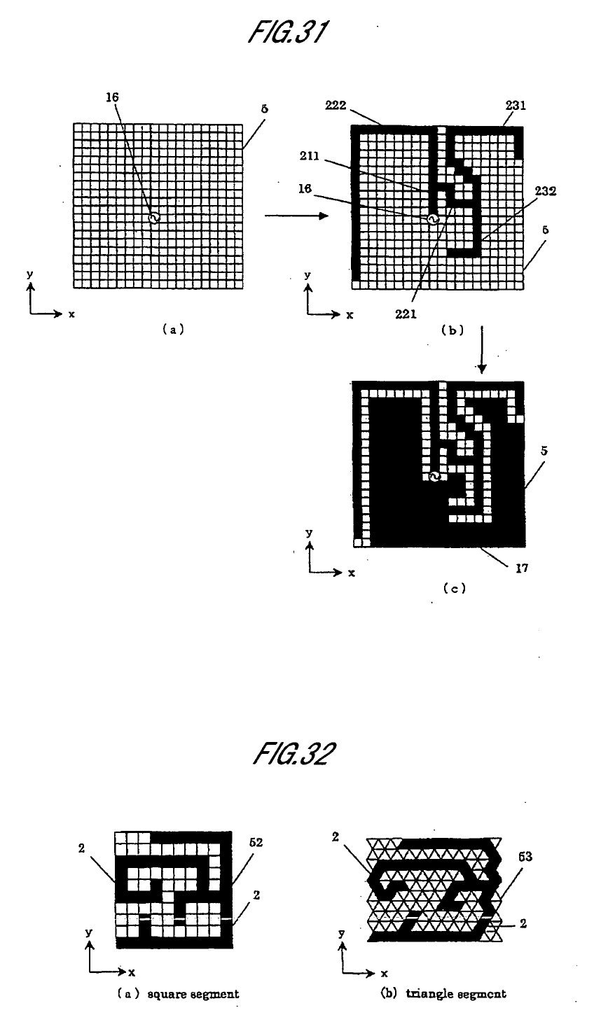

FIG. 31 shows a method for securing the earthing conductive portion (ground) 17 instead of using the method as shown in FIG. 30.

First, the feeding point 16 is defined in the arrangement region as shown in FIG. 31(a). The feeding point is set to be the starting point of the structure arrangement. FIG. 31(b) shows an arrangement pattern computed for the conditions in FIG. 31(a) by the pattern extraction computational algorithm of the invention. In detail, in the matrix with information of the minute area, the feeding point 16 and a segment where the end of the element #32 (232) in FIG. 29 are set to be starting points, and the identifiers ▪ 11 are inputted to all the segments that can be sequentially connected thereto and can be arranged therein. Thereby, the earthing conductive portion (ground) 17 can be formed. This processing is conducted in Step XII of the flow chart in FIG. 6. FIG. 31(c) shows an arrangement pattern obtained finally.

Even for the arrangement in this embodiment, the pattern extraction computational algorithm of the invention can be flexibly applied.

FIG. 32(a) shows an example that a structure arrangement composed of a square minute area is conduced based on a topology in a matrix 52 with information of the minute area. FIG. 32(b) shows an example that a structure arrangement composed of a triangle minute area is conduced based on a topology in a matrix 53 with information of the minute area. As shown, it will be appreciated that, when the shape of the minute area is different, the arrangement pattern can be made distinctive along the shape of the minute area even under the same arrangement method.

Such a method that the shape of the minute area is changed to compute the arrangement pattern of the structure based on the topology is useful in the case that the computation result is applied to the other analysis method. In case of using the triangle segment, it can be applied to an analysis structure for the finite element method (FEM) etc. In case of using the square segment, it can be applied to an analysis structure for the finite-difference time-domain method (FD-TD) etc.

The FEM is an analysis method used in the field of electromagnetism, fluid mechanics, and electrical engineering. The FD-TD is an analysis method used in the field of electromagnetism and electrical engineering.

In the invention, all the arrangement patterns can be extracted faster and more completely than the human work while reducing the cost of computer. Therefore, the design cost can be reduced and the design period can be shortened.

Although the invention has been described with respect to the specific embodiments for complete and clear disclosure, the appended claims are not to be thus limited but are to be construed as embodying all modifications and alternative constructions that may occur to one skilled in the art which fairly fall within the basic teaching herein set forth.

What is claimed is:

1. A pattern extraction computational algorithm, comprising:
using a bus, a CPU, a storage area, an input and an output of a computer to conduct the pattern extraction computational algorithm;
storing a size of a limited area, a size of a minute area, a starting point from which the minute area is arranged, a matrix with information on an attribute of an element, and an matrix with information on the minute area in the storage area; and
patterning a structure based on a topology composed of a plurality of elements with attributes by using a rule in the size of the limited area to extract all patterns to accord to the topology.

2. The pattern extraction computational algorithm according to claim 1, wherein:
the rule comprises to divide the size of the limited area into minute areas and to arrange sequentially the minute area into each of the minute areas.

3. The pattern extraction computational algorithm according to claim 2, wherein:
the storage area comprises a matrix with information on a attribute of the plurality of elements, a storage area with information on the size of the limited area, a storage area with information on the size of the minute area, and a storage area with information on the starting point from which the minute area is arranged in the size of the limited area.

4. The pattern extraction computational algorithm according to claim 3, wherein:
the storage area further includes a matrix with information on the minute area.

5. The pattern extraction computational algorithm according to claim 3, wherein:
the matrix with information on the attribute is used to determine the number of times to sequentially arrange the minute segment.

6. The pattern extraction computational algorithm according to claim 4, wherein:
the matrix with information on the attribute and the matrix with information on the minute segment are used to determine the direction of minute segment to be sequentially arranged.

7. The pattern extraction computational algorithm according to claim 4, wherein:
the matrix with information on the attribute and the matrix with information on the minute segment are used to determine the number of the minute segment to be sequentially arranged.

8. The pattern extraction computational algorithm according to claim 5, wherein:
the matrix with information on the minute area is updated in every arrangement of the minute segment.

9. The pattern extraction computational algorithm according to claim 5, wherein:
the number of times to sequentially arrange the minute segment is determined by standardizing the attribute of the element by dimensions of the minute segment.

10. The pattern extraction computational algorithm according to claim 6, wherein:
the direction of minute segment to be sequentially arranged is determined by using a random function.

11. The pattern extraction computational algorithm according to claim 6, wherein:
the direction of minute segment to be sequentially arranged is determined by using the number of other minute segments adjacent to the minute segment.

12. The pattern extraction computational algorithm according to claim 8, wherein:
the update of the matrix with information on the minute area in every arrangement of the minute segment is conduced by using an identifier comprising a numerical number, a character and a bit.

13. The pattern extraction computational algorithm according to claim 8, wherein:
the update of the matrix with information on the minute area in every arrangement of the minute segment is conducted by the existence of the minute segment sequentially arranged.

14. The pattern extraction computational algorithm according to claim 8, wherein:
information on the arrangement of the minute segment is written into the matrix with information on the minute area in the update for every arrangement of the minute segment.

15. The pattern extraction computational algorithm according to claim 3, wherein:
the inputting to the corresponding storage area of the size of the limited area, the size of the minute area, and the starting point from which the minute area is arranged is conducted by the reading of an electronic file or a dedicated user interface.

16. The pattern extraction computational algorithm according to claim 3, wherein:
writing into the matrix with information on the attribute of the element is conducted by the reading of an electronic file or a dedicated user interface.

17. The pattern extraction computational algorithm according to claim 1, wherein:
all the patterns to accord to the topology are stored in an electronic file.

18. The pattern extraction computational algorithm according to claim 1, wherein:
an arrangement pattern that comprises a numerical number, a character and a bit is output as a result of the algorithm.

19. The pattern extraction computational algorithm according to claim 1, wherein:
a coordinate value of an arrangement pattern is output as a result of the algorithm.

20. The pattern extraction computational algorithm according to claim 1, wherein:
the attribute of the element is composed in two dimensional structure of a length and a width thereof.

21. The pattern extraction computational algorithm according to claim 1, wherein:
the attribute of the element is composed in three dimensional structure of a length, a width and a height or thickness thereof.

22. The pattern extraction computational algorithm according to claim 1, wherein:
the attribute of the element comprises an electrical characteristic.

23. The pattern extraction computational algorithm according to claim 1, wherein:
the attribute of the element comprises a fluid characteristic.

24. A design program for automatically arranging a structure based on a topology, comprising:
the pattern extraction computational algorithm as defined in claim 1.

25. A simulator for the design or characteristic analysis of an electrical circuit, comprising:
the pattern extraction computational algorithm as defined in claim 1.

26. A simulator for an electromagnetic characteristic analysis, comprising:
the pattern extraction computational algorithm as defined in claim 1.

27. A simulator for a fluid characteristic analysis, comprising:
the pattern extraction computational algorithm as defined in claim 1.
